(19) United States
(12) Patent Application Publication
(10) Pub. No.: US 2015/0006202 A1
(43) Pub. Date: Jan. 1, 2015

(54) BIOLOGICAL DATA MANAGEMENT METHOD, BIOLOGICAL DATA MANAGEMENT SYSTEM, AND CENTER APPARATUS

(71) Applicant: Kabushiki Kaisha Toshiba, Tokyo (JP)

(72) Inventors: Kumiko Yamato, Kanagawa-ken (JP); Kazunori Hashimoto, Saitama-ken (JP)

(73) Assignee: KABUSHIKI KAISHA TOSHIBA, Tokyo (JP)

(21) Appl. No.: 14/193,385

(22) Filed: Feb. 28, 2014

(30) Foreign Application Priority Data
Jun. 28, 2013 (JP) 2013-136866

(51) Int. Cl. G06F 19/00

(52) U.S. Cl. CPC G06F 19/322
USPC 705/3

(57) ABSTRACT

Patient identification information for identifying a patient is registered in a server, and measurement device identification information of a measurement device, assigned to each patient, configured to measure biological data of the patient is registered in the server in association with the patient identification information. Also, measurement data is acquired by measuring the biological data of the patient by the measurement device, the measurement data and the measurement device identification information are transmitted from the measurement device to the server, and the measurement data is registered in the server in association with the measurement device identification information.

### CROSS-REFERENCE TO RELATED APPLICATION

This application is based upon and claims the benefit of priority from the prior Japanese Patent Application No. 2013-136866 filed on Jun. 28, 2013; the entire contents of which are incorporated herein by reference.

### FIELD

An embodiment described herein relates generally to a biological data management method, a biological data management system, and a center apparatus.

### BACKGROUND

Conventionally, in medical facilities, various types of vital data (biological data of a patient) such as a body temperature, a blood pressure, and a blood sugar level are measured, collected and managed with an aim to grasp a state of health of a hospitalized patient. More specifically, a nurse or the like visits patient rooms, and records the biological data as mentioned above measured for each patient on a predetermined sheet of paper or the like. Then, the biological data which has been recorded is manually input to an electronic terminal such as a personal computer, is transmitted to a predetermined server, and is accumulated/managed.

At the time of transmitting the recorded biological data to the server, personal information of the patient (for example, a name of the patient and a patient ID) has to be transmitted together with the biological data so that the patient to whom the biological data belongs may be identified. However, frequent communication of personal information of a patient increases a possibility of leakage of personal information, and there is an issue concerning security.

### BRIEF DESCRIPTION OF THE DRAWINGS

FIG. 1 is a schematic block diagram for describing a configuration of a biological data management system according to an embodiment of the present invention;

FIG. 2 is a flowchart for describing a procedure of registering measurement data in a server 3;

FIG. 3 is a diagram for describing an example of a correspondence table of measurement data and device ID stored in the server 3;

FIG. 4 is a flowchart for describing a procedure of registering a device ID in the server 3;

FIG. 5 is a diagram for describing an example of a correspondence table of device ID and user ID stored in the server 3; and

FIG. 6 is a diagram for describing an example of a list of user IDs, device IDs, and measurement data.

### DETAILED DESCRIPTION

A biological data management method of the present embodiment registers patient identification information for identifying a patient in a center apparatus, and registers, in the center apparatus, in association with the patient identification information, measurement device identification information for identifying a measurement device that is assigned to each patient and that measures biological data of the patient. Measurement data is acquired by measuring the biological data of the patient by the measurement device, the measurement data and the measurement device identification information are transmitted from the measurement device to the center apparatus, and the measurement data is registered in the center apparatus in association with the measurement device identification information.

In the following, an embodiment will be described with reference to drawings.

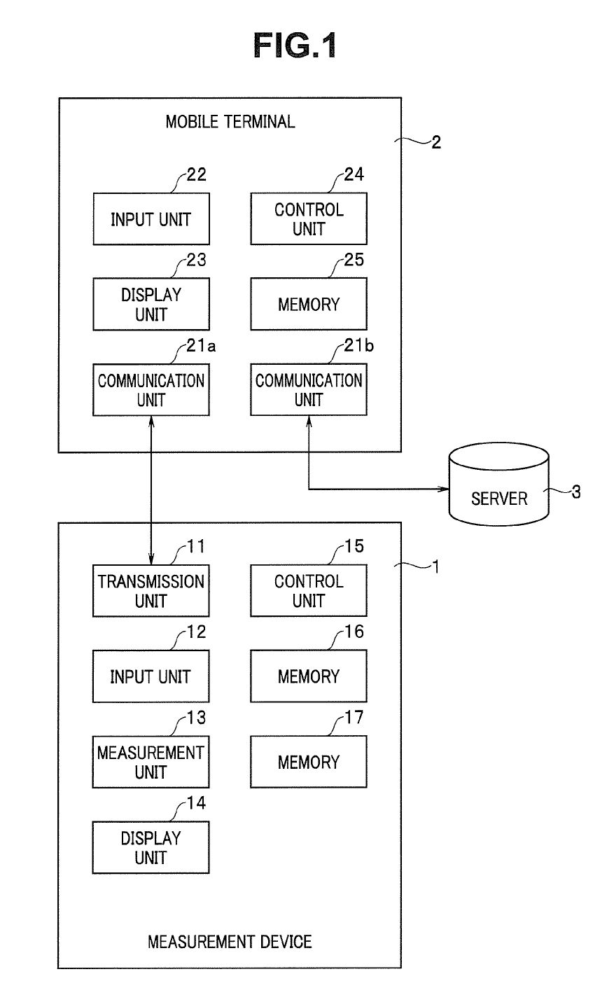

FIG. 1 is a schematic block diagram for describing a configuration of a biological data management system according to the present embodiment. As shown in FIG. 1, the biological data management system of the present embodiment includes a measurement device 1 configured to measure biological data of a patient, a mobile terminal 2, as a dedicated terminal, configured to transmit the data measured by the measurement device 1 (hereinafter referred to as measurement data) to a server 3, and the server 3, as a center apparatus, configured to accumulate the measurement data.

The measurement device 1 includes a transmission unit 11 configured to transmit the measurement data to the mobile terminal 2, an input unit 12 configured to set an instruction regarding measurement, and a measurement unit 13 configured to measure the biological data. Furthermore, the measurement device 1 includes a display unit 14 configured to display the measurement data and the like, a control unit 15 configured to control the operation of each unit inside the measurement device 1, and memories 16 and 17.

The input unit 12 is capable of instructing that a power of the measurement device 1 be turned on or off, of setting a measurement condition, or of setting a transmission instruction (transmission condition) of the measurement data to the mobile terminal 2. For example, the input unit 12 is configured from a slide switch, a push button or the like. The display unit 14 may display, in addition to the measurement data, a date of measurement, a past record, a remaining amount of a battery and the like. Note that the display unit 14 is provided as necessary, and may be omitted.

The memory 16 as a first storage unit stores a record or a measurement condition of past measurement data, information about the timing of transmitting the measurement data from the measurement device 1 to the mobile terminal 2, and the like, and a rewritable memory such as a DRAM or an SRAM is used. The memory 17 as a second storage unit stores information for uniquely identifying each measurement device 1 (measurement device identification information; for example, a device ID or the like), and a non-rewritable memory such as an EEPROM, a flash memory, or a mask ROM is used.

The information for uniquely identifying each measurement device 1 is not restricted to the device ID, and a physical unclonable function (PUF) or information in a memory in an uninitialized state may be used, for example. In the case of using the device ID as the information for uniquely identifying the measurement device 1, the device ID is registered in the measurement device 1 at least before the measurement device 1 is handed to a patient, such as during the manufacturing process or at the time of shipping.

Note that with the biological data management system of the present embodiment, biological data such as a body temperature, a blood pressure, and a blood sugar level are managed. As concrete examples of the measurement device 1 in this case, a thermometer, a sphygmomanometer, a blood sugar level measurement device, and the like may be cited. Also, according to the present embodiment, each measurement device 1 is assigned to a specific patient, and is not used by other patients. Accordingly, if the patient is identified, the measurement device 1 that is used by the patient is identified, and reversely, if the measurement device 1 is identified, the patient who uses the measurement device 1 is identified.

As the mobile terminal 2, a portable PC (for example, a tablet PC or a smartphone) or a dedicated terminal for measurement data transmission/reception is used. The mobile terminal 2 includes communication units 21a and 21b configured to communicate measurement data between the measurement device 1 and the server 3, an input unit 22 configured to set a transmission instruction (transmission condition) of the measurement data to the server 3, and a display unit 23 configured to display a status of communication with the measurement device 1 or the server 3. Furthermore, the mobile terminal 2 includes a control unit 24 configured to control the operation of each unit inside the mobile terminal 2, and a memory 25 configured to store the measurement data, the transmission instruction (transmission condition) to the server 3, and the like.

The input unit 22 is configured from a touch panel or the like, for example. Also, as the memory 25, a rewritable memory such as a DRAM or an SRAM is used, for example. Note that the mobile terminal 2 is not restricted to a portable terminal, and may be a fixed device such as a desktop PC, for example. Also, for example, a shared terminal that is used for transmission/reception of other types of data in a hospital may also be used instead of a terminal that is dedicated to the measurement data.

The server 3 stores various types of data such as the measurement data, information of the measurement device 1, and information of patients. The server 3 stores a patient and the measurement device 1 used by the patient in association with each other. Also, the server 3 stores information of the measurement device 1 and the measurement data in association with each other. Accordingly, when a patient is identified, the measurement data of the patient may be extracted.

Note that transmission/reception of data between the measurement device 1 and the mobile terminal 2, and transmission/reception of data between the mobile terminal 2 and the server 3 may be performed by wireless communication such as infrared rays or Bluetooth, or by wired communication by connecting communication interfaces, not shown, of the transmission unit 11, the communication unit 21a, the communication unit 21b, and the server 3 by cables. Moreover, one communication (for example, the communication between the measurement device 1 and the mobile terminal 2) may be performed wirelessly, and the other communication (for example, the communication between the mobile terminal 2 and the server 3) may be performed in a wired manner. Furthermore, a configuration of performing communication by switching between wireless communication and wired communication is also possible.

Next, a procedure of registering various types of information and data in the server 3, that is, the biological data management method according to the present embodiment will be described. As described above, information of a patient, the measurement data, and information of the measurement device 1 are registered in the server 3. First, registration of the information of a patient will be described. The information of a patient to be registered in the server 3 is, for example, personal information such as the name of the patient, and an ID for uniquely identifying the patient (patient identification information; hereinafter referred to as a user ID). Registration of information may be performed by directly writing the information to the server 3, or by transmitting the information from the mobile terminal 2 to the server 3 and registering the same in the server 3. Also, registration may be performed by using a terminal other than the mobile terminal 2 (for example, a system sharing terminal of a hospital).

When the information of a patient is registered in the server 3, it becomes possible to access the server 3 by using the user ID, and to view only the measurement data associated with the user ID among the measurement data registered in the server 3. (That is, the user ID is a log-in ID for the biological data management system.)

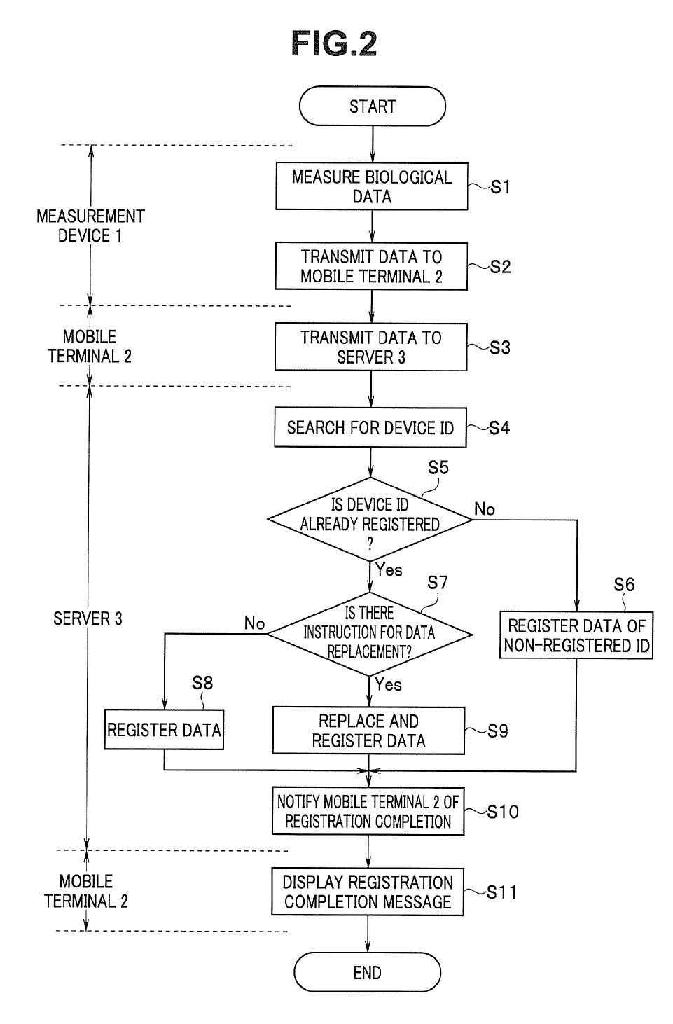

Next, a procedure of registering the measurement data in the server 3 will be described. FIG. 2 is a flowchart for describing a procedure of registering the measurement data in the server 3. First, in step S1, the biological data of a patient is measured by using the measurement device 1. Note that, as described above, each measurement device 1 is a device dedicated to a specific patient, and is not used by other patients.

Next, the procedure proceeds to step S2, and information for identifying the measurement device 1 (in the following description, the device ID is used as an example) and the measurement data are transmitted to the mobile terminal 2. The measurement device 1 includes, regarding the timing for transmitting the measurement data and the like to the mobile terminal 2, two types of transmission modes, namely, a mode for automatic transmission and a mode for manual transmission. One of the modes is selected and is set in the memory 17 before measurement of the biological data (selection of a mode, and setting information regarding the transmission timing in the automatic transmission mode are registered in the memory 17 via the input unit 12). Thus, step S2 is performed according to the transmission mode set in the measurement device 1.

For example, in the case where the automatic transmission mode is selected for the measurement device 1, and the transmission timing is set such that transmission of biological data to the mobile terminal 2 is started immediately after measurement is completed, step S2 is also performed immediately after step S1 is performed. Also, for example, in the case where the automatic transmission mode is selected, and the transmission timing is set such that transmission to the mobile terminal 2 is started at a predetermined time (for example, eight in the morning, twelve noon, seven in the evening, etc.), step S2 is not performed until the predetermined time is reached even if step S1 is completed, and a transmission wait state is reached.

Note that in the case where biological data is measured by the same measurement device 1 again during the transmission wait state, the measurement data which is already stored in the measurement device 1 but is not yet transmitted is replaced with the measurement data acquired by the remeasurement, for example. When the predetermined time is reached, the measurement data acquired by the remeasurement is transmitted to the mobile terminal 2. Alternatively, both of the measurement data which is already stored in the measurement device 1 but is not yet transmitted and the measurement data acquired by the remeasurement may be stored in the memory 16 without performing replacement of the measurement data, and all the pieces of measurement data which are stored in the memory 16 but are not yet transmitted may be transmitted to the mobile terminal 2 at the predetermined time.

Also, in the case where a mode is not selected, or in the case where the manual transmission mode is selected, step S2 is not performed until a nurse or the like inputs a data transmission instruction from the input unit 12, and the transmission wait state is reached.

When the measurement data is transmitted from the measurement device 1 to the mobile terminal 2, the mobile terminal 2 transmits the received measurement data and the device ID of the measurement device 1 which is the transmission source of the measurement data to the server 3 (step S3). Also with respect to the transmission timing of data from the mobile terminal 2 to the server 3, there are an automatic transmission mode and a manual transmission mode, as in the case of the measurement device 1 described above.

Note that in the case where the measurement data is transmitted from the measurement device 1 to the mobile terminal 2 during the transmission wait state, the measurement data which is already stored in the mobile terminal 2 but is not yet transmitted is replaced with the measurement data which is newly transmitted from the measurement device 1. When the predetermined time is reached, the newly acquired measurement data is transmitted to the server 3. Alternatively, both of the measurement data which is already stored in the mobile terminal 2 but is not yet transmitted and the measurement data which has newly been transmitted from the measurement device 1 may be stored in the memory 25 without performing replacement of the measurement data, and all the pieces of measurement data which are stored in the memory 25 but are not yet transmitted may be transmitted to the server 3 at the predetermined time.

The mobile terminal 2 transmits the device ID and the measurement data to the server 3 according to the mode set in advance. Note that in the case of replacing (overwriting) the measurement data already registered in the server 3 with the measurement data to be transmitted, an instruction for replacement is transmitted together with the data.

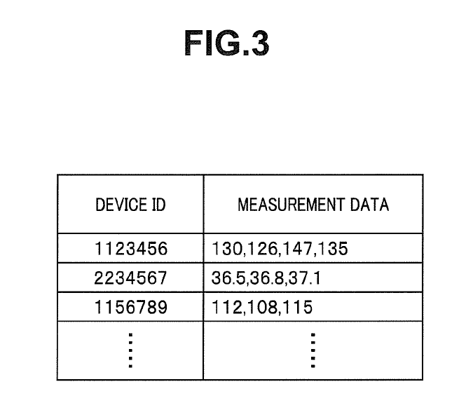

Subsequently, the server 3 registers the measurement data which has been received, in association with the device ID. For example, the device ID and the measurement data are registered in the server 3 in association with each other as shown in FIG. 3. FIG. 3 is a diagram for describing an example of a correspondence table of measurement data and device ID stored in the server 3.

First, the server 3 searches for the device ID which has been received (step S4). Then, whether the device ID which has been received is registered or not is determined (step S5). In the case where the device ID is not registered, the measurement data which has been received is registered as data measured by a non-registered measurement device (step S6).

More specifically, for example, a row is created in the table shown in FIG. 3 for the device ID which has been received, and the measurement data which has been received is written in the column of measurement data for the row. Then, a flag indicating a non-registered device is added such that the data may be identified as data measured by a non-registered measurement device. Also, for example, a table for storing measurement data from a measurement device 1 whose device ID is registered and a table for storing measurement data from a measurement device 1 whose device ID is not registered may be separately prepared, and in the case where the device ID which has been received is not registered, the measurement data may be written in the table for storing measurement data from a measurement device 1 whose device ID is not registered.

On the other hand, in the case where the device ID is registered, whether the measurement data which is already registered is to be replaced with the measurement data which has been received is determined (step S7). In the case where a replacement instruction regarding the measurement data is not received from the mobile terminal 2, the procedure proceeds to step S8, and the measurement data is registered in association with the device ID.

In the case where, in step S7, a replacement instruction regarding the measurement data is received from the mobile terminal 2, the procedure proceeds to step S9, and the measurement data which is already registered is deleted, and the measurement data which has been received is registered in association with the device ID. More specifically, for example, a cell corresponding to the device ID which has been received is extracted from the column of device IDs in the table shown in FIG. 3. The contents of the cell of the measurement data in the row including the cell is overwritten by the measurement data which has been received.

When registration of the measurement data is completed in step S6, S8 or S9, the procedure proceeds to step S10, and a notification to the effect that registration of the measurement data which has been received is completed is issued to the mobile terminal 2. At this time, in the case where the measurement data of a non-registered device ID is registered, a notification to the effect that the device ID is not registered may be issued by the server 3 to the mobile terminal 2, together with the notification regarding registration completion. When the registration completion notification is received from the server 3, the mobile terminal 2 displays a registration completion message on the display unit 23 (step S11). With the series of processes described above, registration of the biological data measured by the measurement device 1 in the server 3 is completed.

Note that in FIG. 2, steps S1 and S2 are procedures related mainly to the measurement device 1, and steps S3 and S11 are procedures related mainly to the mobile terminal 2. Also, steps S4 to S10 are procedures related mainly to the server 3.

The procedure described above is a procedure of registering the measurement data in association with the device ID, but the data to be registered is not restricted to the measurement data, and information that is auxiliary to the measurement data (for example, date of measurement) may be transmitted together and be registered in association with the measurement data.

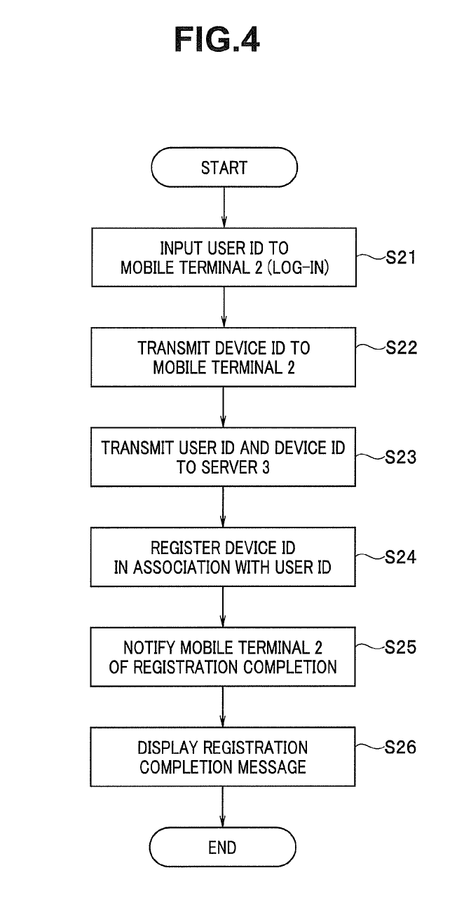

Lastly, a procedure of registering the device ID in the server 3 will be described. FIG. 4 is a flowchart for describing a procedure for registering the device ID in the server 3. First, in step S21, a user ID is input to the mobile terminal 2, and the server 3 is accessed (log-in to the biological data management system is performed). Then, the measurement device 1 that is to perform registration transmits the device ID to the mobile terminal 2 (step S22). The mobile terminal 2 transmits the device ID which has been received and the user ID to the server 3 (step S23).

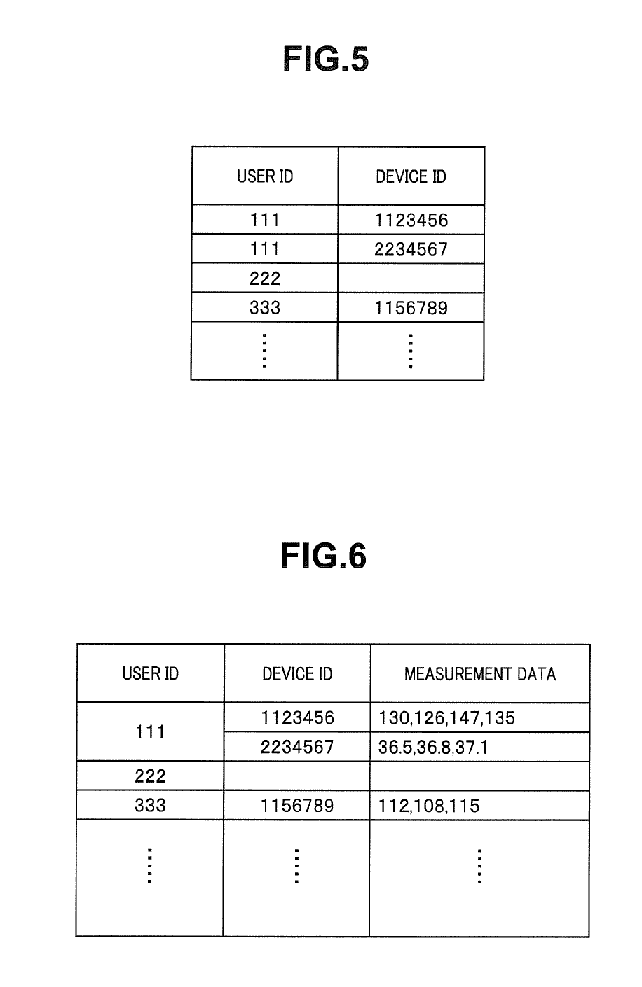

The server 3 registers the device ID which has been received, in association with the user ID (step S24). For example, the user ID and the device ID are registered in the server 3 in association with each other as shown in FIG. 5. FIG. 5 is a diagram for describing an example of a correspondence table of device ID and user ID stored in the server 3.

When registration of the device ID is completed, the procedure proceeds to step S25, and a notification to the effect that registration of the device ID which has been received is completed is issued to the mobile terminal 2. When the registration completion notification is received from the server 3, the mobile terminal 2 displays a registration completion message on the display unit 23 (step S26). Registration of the device ID in the server 3 is completed by the series of processes described above.

Note that according to the procedure shown in FIG. 4, registration of the device ID is performed by using the mobile terminal 2, but this is not restrictive, and for example, another terminal that is connected to the server 3 may be used, or writing may be directly performed to the server 3.

Also, registration of the device ID does not have to be performed after the registration of the measurement data, and may be performed before the registration of the measurement data or at the same timing. For example, when measuring the biological data by using a non-registered measurement device 1, the device ID may be registered at the same timing as simultaneous registration of the device ID and the measurement data in the server 3 at the time of first measurement. Nevertheless, the user ID has to be registered in the server 3 before the device ID and the measurement data.

Furthermore, the correspondence table of user ID and device ID and the correspondence table of device ID and measurement data may be combined into one table as shown in FIG. 6 and be stored in the server 3. FIG. 6 is a diagram for describing an example of a list of user IDs, device IDs, and measurement data.

As described, according to the present embodiment, when registering the measurement data in the server 3, the user ID, which is personal information of a patient, and the measurement data do not have to be transmitted together except for when registering the device ID at the same timing as the simultaneous registration of the device ID and the measurement data, and leakage of personal information may be restrained, and the security may be increased.

Also, according to the present embodiment, the biological data measured by the measurement device 1 is transmitted to the server 3 via the mobile terminal 2 in a state of electronic data, and is registered. Accordingly, the conventional burden of a nurse to write the measurement data on a predetermined sheet of paper and to input the data in an electronic terminal may be eliminated, and the work efficiency may be increased. Moreover, since data does not have to be manually input, an input error may be prevented, and the reliability of data may be increased.

Note that in the example described above, the biological data measured by the measurement device 1 is registered in the server 3 via the mobile terminal 2, but the mobile terminal 2 does not necessarily has to be used. That is, the measurement device 1 and the server 3 may be directly connected in a wireless or wired manner, and the measurement data may be transmitted and registered in the server 3 from the measurement device 1.

Each “unit” in the present specification is a concept corresponding to each function in the embodiment, and does not necessarily correspond to specific hardware or a software routine in a one-to-one manner. Accordingly, in the present specification, the embodiment has been described assuming a virtual circuit block (unit) having each function of the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such farms or modifications as would fall within the scope and spirit of the inventions.

What is claimed is:

1. A biological data management method comprising:
registering patient identification information for identifying a patient in a center apparatus;
registering, in the center apparatus, in association with the patient identification information, measurement device identification information for identifying a measurement device that is assigned to each patient and that measures biological data of the patient;
acquiring measurement data by measuring the biological data of the patient by the measurement device;
transmitting the measurement data and the measurement device identification information from the measurement device to the center apparatus; and
registering the measurement data in the center apparatus in association with the measurement device identification information.

2. The biological data management method according to claim 1, wherein the center apparatus receives the patient identification information only at a time of registration of the patient identification information in the center apparatus or at a time of registration of the measurement device identification information in the center apparatus.

3. The biological data management method according to claim 1, wherein when the measurement data and the measurement device identification information are transmitted from the measurement device to the center apparatus, whether the measurement device identification information is registered in the center apparatus is determined, and in a case where the measurement device identification information is determined to be not registered in the center apparatus, the measurement data that is received is registered in the center apparatus as measurement data that is measured by a non-registered measurement device.

4. The biological data management method according to claim 3, wherein in a case where the measurement device identification information is determined to be registered in the center apparatus, whether a replacement instruction is received to replace the measurement data that is already registered in the center apparatus with the measurement data that is received is determined, and in a case where the replacement instruction is not received, the measurement data that is received is registered in the center apparatus in association with the measurement device identification information, and in a case where the replacement instruction is received, the measurement data that is already registered is deleted and the measurement data that is received is registered in the center apparatus in association with the measurement device identification information.

5. The biological data management method according to claim 1, wherein the patient identification information is transmitted to the center apparatus via a dedicated terminal that is configured to receive the measurement data transmitted from the measurement device and to transmit the measurement device identification information and the measurement data that is received to the center apparatus, only at a time of registration of the patient identification information in the center apparatus or at a time of registration of the measurement device identification information in the center apparatus.

6. The biological data management method according to claim 5, wherein the center apparatus receives the patient identification information only at a time of registration of the patient identification information in the center apparatus or at a time of registration of the measurement device identification information in the center apparatus.

7. The biological data management method according to claim 5, wherein when the measurement data and the measurement device identification information are transmitted from the measurement device to the center apparatus, whether the measurement device identification information is registered in the center apparatus is determined, and in a case where the measurement device identification information is determined to be not registered in the center apparatus, the measurement data that is received is registered in the center apparatus as measurement data that is measured by a non-registered measurement device.

8. The biological data management method according to claim 5, wherein in a case where the measurement device identification information is determined to be registered in the center apparatus, whether a replacement instruction is received to replace the measurement data that is already registered in the center apparatus with the measurement data that is received is determined, and in a case where the replacement instruction is not received, the measurement data that is received is registered in the center apparatus in association with the measurement device identification information, and in a case where the replacement instruction is received, the measurement data that is already registered is deleted and the measurement data that is received is registered in the center apparatus in association with the measurement device identification information.

9. A biological data management system comprising:
a measurement device, assigned to each patient, configured to acquire measurement data by measuring biological data of the patient; and
a center apparatus configured to register patient identification information for identifying the patient, measurement device identification information for identifying the measurement device, and the measurement data,
wherein the measurement device transmits the measurement data and the measurement device identification information to the center apparatus, and the center apparatus stores, in association with each other, the measurement data and the measurement device identification information that are received, and also, the center apparatus stores, in association with each other, the patient identification information and the measurement device identification information.

10. The biological data management system according to claim 9, wherein the center apparatus receives the patient identification information only at a time of registration of the patient identification information in the center apparatus or at a time of registration of the measurement device identification information in the center apparatus.

11. The biological data management system according to claim 9, further comprising:
a dedicated terminal configured to receive the measurement data that is transmitted from the measurement device, and to transmit the measurement device identification information and the measurement data that is received to the center apparatus,
wherein the dedicated terminal transmits the patient identification information to the center apparatus only at a time of registration of the patient identification information in the center apparatus or at a time of registration of the measurement device identification information in the center apparatus.

12. The biological data management system according to claim 9,
wherein the measurement device includes a first storage unit allowing rewriting of information that is stored, and
wherein the information that is stored in the first storage unit includes a record of past measurement data, measurement information of the past measurement data, and timing information for transmitting the measurement data to the center apparatus.

13. The biological data management system according to claim 12, wherein the first storage unit is a DRAM or an SRAM.

14. The biological data management system according to claim 9,
wherein the measurement device includes a second storage unit not allowing rewriting of information that is stored, and
wherein the information that is stored in the second storage unit is the measurement device identification information.

15. The biological data management system according to claim 14, wherein the second storage unit is an EEPROM, a flash memory, or a mask ROM.

16. The biological data management system according to claim 9, wherein the measurement device is a thermometer, a sphygmomanometer, or a blood sugar level measurement device for measuring a body temperature, a blood pressure, or a blood sugar level of the patient, where the body temperature, the blood pressure, or the blood sugar level is the measurement data.

17. A center apparatus, wherein the center apparatus registers, in association with each other, measurement data acquired by measuring biological data of a patient and measurement device identification information for identifying a measurement device that measures the biological data, and registers, in association with each other, patient identification information for uniquely identifying the patient to whom the measurement device is assigned and the measurement device identification information.

18. The center apparatus according to claim 17, wherein the center apparatus receives the patient identification information only at a time of registering the patient identification information or at a time of registering the measurement device identification information.
